(19) United States
(12) Patent Application Publication
(10) Pub. No.: US 2020/0208503 A1
(43) Pub. Date: Jul. 2, 2020

(54) Low Pressure-Loss Valve for Rod-Operated Subsurface Pump

(71) Applicant: ExxonMobil Upstream Research Company, Spring, TX (US)

(72) Inventors: Carl J. Dyck, Cold Lake (CA); Federico G. Gallo, Houston, TX (US)

(21) Appl. No.: 16/667,601

(22) Filed: Oct. 29, 2019

Related U.S. Application Data
(60) Provisional application No. 62/868,425, filed on Jun. 28, 2019.
(60) Provisional application No. 62/786,141, filed on Dec. 28, 2018.

(51) Int. Cl. E21B 43/12; F16K 15/04

(52) U.S. Cl. CPC E21B 43/123; F16K 15/04; E21B 43/126

(57) ABSTRACT

A valve for a positive displacement pump, designed for use in an artificial lift system. The valve may be either a traveling valve or a standing valve. The valve comprises a cylindrical cage, and includes a ball residing within the cage. In an open position, the ball floats up off of a seat, while in a closed position the ball sealingly lands onto the seat. The cage includes a cone to guide fluid flow after it passes the ball and reduce turbulence and pressure loss through the valve. An intake below the seat gradually reduces in diameter, providing a minimum inner diameter that is less than a diameter of the seat.

### CROSS REFERENCE TO RELATED APPLICATION

This application claims the benefit of U.S. Provisional Application 62/868,425 filed Jun. 28, 2019 entitled “Low Pressure-Loss Valve for Rod-Operated Subsurface Pump” and U.S. Provisional Application 62/786,141, entitled “Reciprocating Pump Ball and Seat Valve,” filed on Dec. 28, 2018 the entireties of which are incorporated by reference herein.

### BACKGROUND OF INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### Field of the Invention

The present disclosure relates to the field of hydrocarbon recovery operations. More specifically, the present invention relates to subsurface pumps operated through reciprocating sucker rods or endless (coiled) rods. Further still, the present invention relates to a valve assembly that provides for reduced pressure loss in a downhole positive displacement pump.

### Technology in the Field of the Invention

When a hydrocarbon-producing well is first placed on-line, the formation pressure is typically capable of driving produced fluids up the wellbore and to the surface. Liquid fluids will travel up to the surface through the production tubing, primarily in the form of entrained droplets. During the life of the well, the natural reservoir pressure will decrease as gases and liquids are removed from the formation. As the natural downhole pressure of the well decreases, the gas velocity moving up the well drops below a so-called critical flow velocity. In addition, the hydrostatic head of fluids in the wellbore will work against the formation pressure and block the flow of in situ gas into the wellbore. The result is that formation pressure is no longer able, on its own, to force fluids from the formation and up the production tubing in commercially viable quantities.

In response, various remedial measures have been taken by operators. One option is to simply reduce the inner diameter of the production tubing a small amount, thereby increasing pressure differential. Another technique is through the use of a downhole reciprocating pump. Such pumps may include a valve that is attached to the tubing or seated within an internal constriction, or “seating nipple,” of the tubing. Such a valve is referred to as a standing valve. Such pumps may also include a valve that is connected to a lower end of a string of sucker rods. Such a valve is referred to as a traveling valve.

In operation, the sucker rods are moved up and down within the production tubing in response to mechanical movement of a pumping unit at the surface. Various types of pumping units are known, with modern pumping units being fitted with rod pump controllers that control pump times and stroke speeds. The sucker rods move the traveling valve through upstrokes and downstrokes, where fluids are drawn into the traveling valve on the downstroke, and then lifted up the production tubing on the upstroke. At the same time, the standing valve receives fluids from the surrounding formation during the traveling valve's upstroke, and is sealed in response to fluid pressure during the traveling valve's downstroke.

Both the traveling valve and the standing valve represent so-called ball and seat valves. The balls are cyclically lifted up off of the seats and then urged back down onto the seats in response to pressure changes caused by the pump strokes. Production fluids enter the valves through respective seats when the balls are off of the seats.

Those of ordinary skill in the art will understand that it is important for the production fluids to flow easily through the valve in the open position when the ball is off the seat. A condition known as pressure loss can occur due to velocity, friction and turbulence while fluids are flowing through the tortuous and restricted passageways formed by the valve. Pressure loss through any downhole valve is highly dependent on fluid velocity. Wells with higher production rates and higher pump stroke rates are more sensitive to the effects of pressure loss.

Pressure loss through the standing valve can limit pump fillage and thereby limit production rates. This is especially true where the produced liquid is near its bubble point, near its flash point, and/or has high viscosity. Pressure loss through the travelling valve can slow the rate of rod fall and cause “hang-up” in high viscosity fluid conditions. This requires that the pump be stroked more slowly, limiting its rate of production.

In high temperature wells, and particularly in wells undergoing cyclic steam stimulation (or “CSS”), the water at the standing valve intake is at saturated conditions during parts of each production cycle, and is at or below the bubble point pressure of the oil. This means that any incremental pressure drop will cause water to flash (boil) to vapor (steam), and may cause gas to exolve from the oil. Additionally, late in the CSS cycle, high oil viscosities are encountered. Examples of fields where CSS operations take place are the Peace River oil sands, the Athabasca oil sands and the Cold Lake oil sands, all in Alberta, Canada. While CSS operations are significantly impacted by production conditions at saturation conditions and below the bubble point of the oil, these phenomena are not limited to CSS operations.

At or near saturated conditions pressure loss across the standing valve will cause water to flash to vapor. At or near the bubble point, pressure loss across the standing valve will cause gas to exolve out of the oil. The vapor and gas produced by these effects can consume a significant fraction of the total displacement of the pump, especially for wells that are drawn down to a low bottom hole pressure. The volume within the pump barrel that is filled with vapor cannot, by definition, be filled with liquid, hence reducing pump fillage, efficiency and production rates.

Pressure loss is also a concern in the traveling valve. Pressure drop across the traveling valve limits pump fillage. Pressure loss is also the primary source of compressive loads in the rod string, which cause buckling. Buckling, in turn, produces so-called hang-up that limits the stroke rate, limiting production. Hang-up is also a potential integrity concern for bent and broken polish rods.

In an effort to reduce pressure loss and to increase fluid flow through the two valves, production engineers have designed valves having increased cross-sectional areas. The object is to reduce the velocity of production fluids as they flow through the seat and around the ball. However, cross-sectional flow area can only be increased to certain limits due to size, geometry, and structural constraints for downhole applications.

To further reduce pressure loss, U.S. Pat. No. 5,593,292 offered a “valve cage” wherein the wall had a streamlined and gradual profile between the lower seat and an upper ball-stop. The bore through the valve was “tapered and upwardly enlarging,” permitting fluids to more freely travel around the ball when the valve opened.

U.S. Pat. No. 6,899,127 sought to improve upon the '292 patent by limiting turbulent flow below and around the ball. For this purpose, the dimensions of the upstream and downstream transition sections of the valve were mathematically tuned to provide a more laminar flow. Both designs ultimately seek to reduce pressure loss by reducing turbulence through the valve when the valve is in its open position.

A need still exists for an improved cage design for rod pump valves that minimizes pressure loss while allowing fluid to flow through the valve. A need also exists for a cage that centralizes the ball as the valve is opening and closing, particularly for wells that are deviated or horizontal. Still further, a need exists for a cage design that provides for an increased contact area between the upper ball stop and the ball itself when the valve is fully open, thereby minimizing wear of parts during use downhole.

### BRIEF SUMMARY OF THE DISCLOSURE

A valve for a positive displacement pump (also known as a downhole sucker rod pump) is first provided herein. The valve is designed for use in an artificial lift system. The artificial lift system, in turn, is used for the production of hydrocarbons from a well.

The valve may be a traveling valve. In this instance, an upper portion of the valve is configured to be threadedly connected to a plunger at the lower end of a sucker rod string. Alternatively, the valve may be a standing valve in an insert pump. In this instance, the valve is threadedly connected to a barrel and connected to the tubing, typically by a seal assembly that is configured to land in a seating nipple along the i.d. of the production tubing.

In one embodiment, the valve first comprises a cylindrical body. The cylindrical body has an upper end, a lower end and a tubular side wall. The tubular side wall forms an axial bore through which production fluids may flow from the lower end to the upper end.

The valve also includes a ball. The ball floatingly resides within the cylindrical body above a seat. In an open position the ball floats up off of the seat, while in a closed position the ball sealingly lands onto the seat.

In the present invention, the cylindrical body comprises a cage. The cage includes ball guides along an inner diameter, and a ported, frusto-conical profile, or cone, within the chamber.

The valve additionally comprises a ball stop. The ball stop limits the upward movement of the ball within the cage when the ball floats up off the seat. At the same time, the cage comprises an open bottom. In one aspect, the cone itself serves as the ball stop. In another aspect, a separate ball stop resides immediately below the cone. In any instance, the ball stop prevents the ball from rising up the cage (to an upper end of the cone) when the ball moves to its open position.

As noted, the valve additionally includes a seat. The seat resides immediately below the cage. The seat is configured to sealingly receive the ball when the ball moves to the bottom of the cage, either by gravity or in response to fluid flow or pressure differential. The seat is configured to permit fluids to flow through the seat and around the ball when the ball is in the open position within the cage, that is, the ball has moved up against the ball stop.

The seat is held and sealed in position within the valve assembly by a lower portion of the tubular body, referred to as a strainer bushing. The strainer bushing is preferably a separate tubular body that is threadedly connected to the cage. However, the present invention allows for the cage, the strainer bushing and the intermediate seat to be an integral piece.

The strainer bushing has an inner diameter that is tapered or rounded. In this way, a minimum inner diameter is formed that is slightly less than an inner diameter of the seat. This allows an intake of fluids to be more streamlined, reducing turbulent flow below the ball.

As noted, ball guides are placed within the cylindrical body as part of the cage. The ball guides reside below the cone, and may be integral to the cone or may be a separate body that is placed into the tubular wall of the cage along with the cone. Fluid openings reside between the ball guides, permitting fluids to flow around the ball and then around the cone when the ball is in the open position off of the seat. Optionally, these flow channels in the lower end of the upper cylindrical body (or cage) have a gradual or curved inside diameter profile between the seat and ball stops that further reduce turbulence as the flow transitions from the seat to around the ball in the open position.

In one embodiment, the cone itself comprises a solid frusto-conical body where intake fluids flow around the frusto-conical body. In a more preferred embodiment, the cone has an open bottom, a ported top, and an open interior there between. In this instance, fluids move through the ported top of the frusto-conical body as the ball lifts off of the seat. The purpose of the ported cone is to allow fluid flow and pressure to act on the top of the ball when the valve needs to close.

A method of pumping fluids from a wellbore is also provided herein. The method first comprises providing a wellbore. The wellbore includes a string of production tubing residing therein. In addition, the wellbore includes a valve for a positive displacement pump along the production tubing.

The valve may be in accordance with the valve discussed above in any of its embodiments. In one aspect, the production tubing holds a sucker rod string and the valve is a traveling valve. Here, an upper end of the cylindrical body is operatively connected to a lower end of the sucker rod string such as by means of a plunger. In another aspect, the valve is a standing valve. In this instance, the standing valve is operatively connected to the production tubing such as by means of a pump barrel.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1A is a side view of a valve for a positive displacement pump.

FIG. 1B is a cross-sectional view of the valve of FIG. 1A.

FIG. 1C is a cut-away view of the valve of FIG. 1A.

FIG. 1D is a perspective view of a lower tubular body of the valve of FIGS. 1B and 1C, in an alternate arrangement.

FIG. 2A is a side view of a valve for a positive displacement pump, in an alternate embodiment.

FIG. 2B is a cross-sectional view of the valve of FIG. 2A.

FIG. 2C is a cut-away view of the valve of FIG. 2A.

FIG. 3A is a side view of a valve for a positive displacement pump, in another alternate embodiment.

FIG. 3B is a cross-sectional view of the valve of FIG. 3A.

FIG. 3C is a cut-away view of the valve of FIG. 3A.

FIG. 4 is a flow chart showing steps for a method of producing hydrocarbon fluids from a wellbore.

FIG. 5 is a side view of a wellbore, having been completed with a horizontal section. A traveling valve is shown at a lower end of a sucker rod string.

### DETAILED DESCRIPTION OF CERTAIN EMBODIMENTS

### Definitions

Various terms as used in the specification and in the claims are defined below. To the extent a term used in the claims is not defined below, it should be given the broadest reasonable interpretation that persons in the upstream oil and gas industry have given that term as reflected in at least one printed publication or issued patent.

For purposes of the present application, it will be understood that the term “hydrocarbon” refers to an organic compound that includes primarily, if not exclusively, the elements hydrogen and carbon. Hydrocarbons may also include other elements, such as, but not limited to, halogens, metallic elements, nitrogen, oxygen, and/or sulfur.

As used herein, the term “hydrocarbon fluids” refers to a hydrocarbon or mixtures of hydrocarbons that are gases or liquids. For example, hydrocarbon fluids may include a hydrocarbon or mixtures of hydrocarbons that are gases or liquids at formation conditions, at processing conditions, or at ambient condition. Hydrocarbon fluids may include, for example, oil, natural gas, coalbed methane, shale oil, pyrolysis oil, pyrolysis gas, a pyrolysis product of coal, and other hydrocarbons that are in a gaseous or liquid state, or combination thereof.

As used herein, the terms “produced fluids,” “reservoir fluids” and “production fluids” refer to liquids and/or gases removed from a subsurface formation, including, for example, an organic-rich rock formation. Produced fluids may include both hydrocarbon fluids and non-hydrocarbon fluids. Production fluids may include, but are not limited to, oil, natural gas, pyrolyzed shale oil, synthesis gas, a pyrolysis product of coal, oxygen, carbon dioxide, hydrogen sulfide and water.

As used herein, the term “fluid” refers to gases, liquids, and combinations of gases and liquids, as well as to combinations of gases and solids, combinations of liquids and solids, and combinations of gases, liquids, and solids.

As used herein, the term “wellbore fluids” means water, hydrocarbon fluids, formation fluids, or any other fluids that may be within a wellbore during a production operation.

As used herein, the term “gas” refers to a fluid that is in its vapor phase. A gas may be referred to herein as a “compressible fluid.” In contrast, a fluid that is in its liquid phase may be referred to as an “incompressible fluid,” although in certain conditions it is understood that a liquid may have some small degree of compressibility.

As used herein, the term “subsurface” refers to geologic strata occurring below the earth's surface.

As used herein, the term “formation” refers to any definable subsurface region regardless of size. The formation may contain one or more hydrocarbon-containing layers, one or more non-hydrocarbon containing layers, an overburden, and/or an underburden of any geologic formation. A formation can refer to a single set of related geologic strata of a specific rock type, or to a set of geologic strata of different rock types that contribute to or are encountered in, for example, without limitation, (i) the creation, generation and/or entrapment of hydrocarbons or minerals, and (ii) the execution of processes used to extract hydrocarbons or minerals from the subsurface.

As used herein, the term “wellbore” refers to a hole in the subsurface made by drilling or insertion of a conduit into the subsurface. A wellbore may have a substantially circular cross section. The term “well,” when referring to an opening in the formation, may be used interchangeably with the term “wellbore.”

### Description of Selected Specific Embodiments

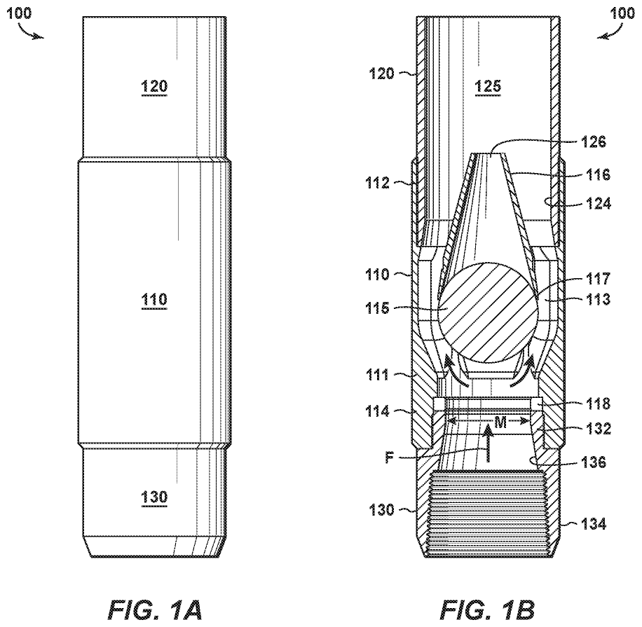

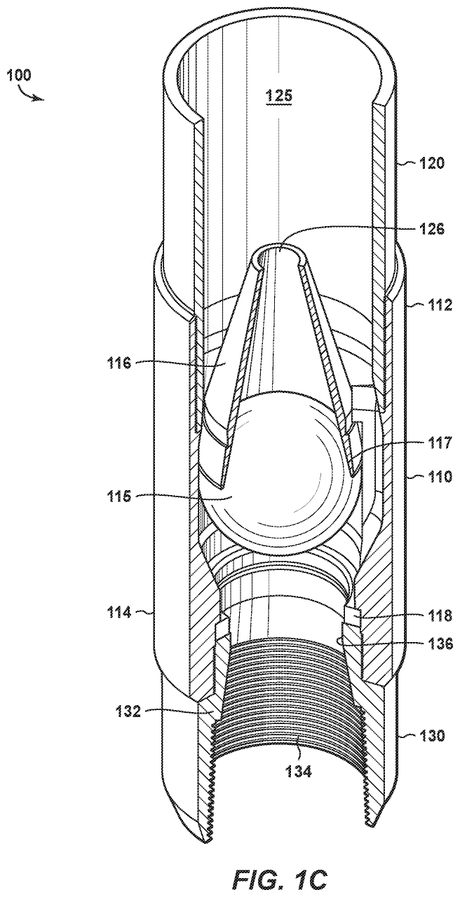

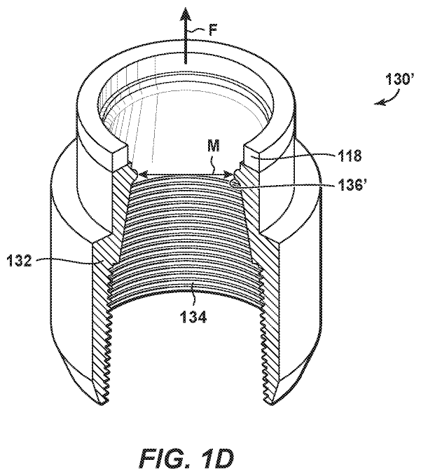

FIG. 1A is a side view of a valve 100 for a positive displacement pump. The valve 100 comprises a cylindrical body. In the arrangement of FIG. 1A the cylindrical body is shown as three separate bodies 110/120/130 which have been threadedly connected. However, it is understood that the cylindrical body may be a single body or, more preferably, a combination of bodies 110/130 and 120.

The valve 100 may be either a standing valve or a traveling valve. If valve 100 is viewed as a standing valve, then the upper tubular body 120 is typically a pump barrel that lands inside of a string of production tubing. If the valve 100 is viewed as a travelling valve, then the upper tubular body 120 is typically a plunger that connects at a lower end of a sucker rod string.

FIG. 1B is a cross-sectional view of the valve 100 of FIG. 1A. FIG. 1C is a cut-away view of the valve of FIG. 1A. The valve 100 will be described with reference to FIGS. 1A, 1B and 1C together.

As noted, the valve 100 comprises cylindrical bodies 110, 120 and 130. Cylindrical body 110 represents a cage. The cage 110 comprises an upper end 112 and a lower end 114. In the illustrative arrangement of FIGS. 1A, 1B and 1C, each of ends 112 and 114 comprises female threads. This is known as a box-by-box configuration.

The cylindrical body 110 defines a generally tubular side wall 111. The side wall 111 forms an axial bore through which production fluids may flow. Arrow “F” demonstrates a direction of fluid flow within the valve 100. Of interest, the box thread arrangement facilitates a larger bore access within the intermediate body 110.

A ball 115 resides within the cylindrical body 110. The ball 115 may be between 0.50 inches and 3.5 inches in diameter. During operation, the ball 115 floats between an open position wherein the ball 115 moves up within the cylindrical body 110, and a closed position wherein the ball 115 falls down onto a seat 118 (described below).

The valve 100 also includes a cone 116. The cone 116 defines a generally frusto-conical body having an open bottom and a ported top 126. The frusto-conical body may have a length of 2 inches, 5 inches or even 10 inches in length. The frusto-conical body may have a tapered angle that is between 1° and 45°, or between 3° and 30°, or between 5° and 15, relative to the longitudinal axis of the valve 100. The length and angle of the elongated cone helps to streamline the flow of production fluids around the ball which would otherwise be turbulent, thereby reducing pressure loss through the cylindrical body 110.

The diameter of the ported top 126 is obviously smaller than the diameter of the ball 115. At the same time, the diameter of the ported top 126 must be large enough to permit the ball to close when the direction of flow reverses. The ported opening 126 provides positive pressure above the ball 115 allowing the ball 115 to more readily release from the seat 118.

The cone 116 is disposed concentrically within the cage 110. The cone portion 116 of the cage 110 defines a wall that converges towards an upper end of the frusto-conical profile. In this way, the cone 116 forms a stop 117 that limits upward movement or “travel” of the ball 115 within the cylindrical body 110. In an alternate embodiment, the cone 116 is located a short distance from a ball stop such that the ball 115 never makes contact with the cone 116.

The cage 110 preferably also includes a series of radially-disposed ball guides 113. The ball guides 113 are configured to support the cone 116 above the seat 118.

Preferably, the entire cage 110, including the outer wall 111, the ball guides 113 and the cone 116 are cast as a single piece. Alternatively, the outer wall 111, the ball guides 113 and the cone 116 are machined from a single piece of bar or tubular stock material. In another arrangement, the cone 116 and the ball guides 113 are machined out of a single piece of bar stock and are inserted into the tubular wall 111 together. Alternatively, the cage 110, that is, the cone 116 and ball guides 113 together, may be separate bodies weldedly, brazedly, adhesively or threadedly connected.

In another arrangement, the tubular wall 111 and ball guides 113 may be machined or cast from a single piece of stock material while the cone 116 defines a separate piece that is welded, brazed or adhered to or otherwise fixed into the ball guides 113. In this instance, the cone 116 and the ball guides 113 may be inserted into the tubular wall 111 from the upper end 112. A soft metal gasket (not shown) may be used to hold the cage 116 in position.

As noted above, the valve 110 also comprises a seat 118. The seat 118 defines a cylindrical body and is typically made from hard wear and erosion resistant materials. Examples of suitable materials include stainless steel, exotic metal alloys, and composite materials such as Tungsten Carbide. The seat 118 is held in place between the cage 110 and the strainer bushing 120. Of importance, the seat 118 is configured to sealingly receive the ball 118.

The seat 118 is located some distance below the cone portion 116 of the cylindrical body 110. This provides a desired clearance, allowing fluids “F” to flow up through the seat 118 and towards the surface when the valve 100 is in its open position. The distance between the seat 118 and the cage 116 may be tuned to maximize fluid intake during pumping while minimizing turbulence below the ball 115.

A step of determining a distance between the seat 118 and the ball stop 117 may be taken during design to minimize pressure loss during a change in valve state between its open and closed positions. In one aspect, this distance is between 0.5 and 7 inches. Typically, the optimal range is between 1 to 2 ball diameters. The designated distance permits fluids to flow through the seat 118 and around the ball 115 when the ball 115 hits the ball-stop 117 formed along the cage 116. It is desirable to minimize the distance to reduce the required ball travel distance and therefore closing time for the valve.

In the arrangement of FIGS. 1A-1C, the cylindrical body comprises a lower tubular body that represents a strainer bushing 130. The strainer bushing 130 includes a top end 132 forming a male threaded end. The male threaded end 132 connects to female threads at the lower end 114 of the cylindrical body 110, or cage.

The strainer bushing 130 typically includes a lower end 134. The lower end 134 typically forms a female threaded end if the valve 100 is a standing valve. If present, the female threaded end 134 may connect with other equipment of the production string such as a sand screen, a strainer, a gas separator, or a gas avoider. Often, no additional equipment is connected below the strainer bushing 130 of the standing valve, in which case the strainer bushing 130 acts directly as the intake for the production fluids.

Also of interest, the strainer bushing 130 includes an area of increased thickness, forming an inwardly-tapered body 136. The inwardly-tapered body 136 has a minimum diameter “M” proximate the point of meeting the seat 118 that is less than the inner diameter of the seat 118 itself. This unique arrangement is used to precondition the fluid flow “F” so that the flow through the seat 118 experiences less turbulence and the valve 100 experiences less pressure loss. For this reason, the inwardly-tapered body 136 may be referred to as an intake funnel.

In the arrangement of FIGS. 1B and 1C, the inwardly-tapered body 136 has a minimum diameter “M” immediately abutting the seat 118 itself. The difference in diameter may be, for example, 0.001 to 0.1 inches. In another embodiment, the point of the smallest inner diameter may be below the point of meeting the seat 118. Pressure loss and turbulence are minimized by a wall profile 136 that is already diverging at the point where it meets the seat 118.

The angle of the inwardly-tapered body 136 relative to a longitudinal axis of the valve 100 may be between 1° and 45° or, more preferably, between 3° and 15°. In one aspect, the seat 118 has an inside diameter of 2.56 inches while the inwardly-tapered body 136 has a minimum inside diameter “M” of approximately 2.5 inches. In one aspect, a length of the inwardly-tapered body 136 is one to three ball-diameters in length.

Preferably, the minimum diameter “D” of the inwardly-tapered body 136 is 0.001 to 0.1 inches less than the diameter of the seat 118. Preferably, the inward taper of the body 136 is gradual, allowing the flow of production fluids at the inlet to converge through the seat 118 before diverging around the ball 115.

FIG. 1D is a perspective view of a lower tubular body 130′ of the valve 100 of FIGS. 1B and 1C, in an alternate arrangement. Here, the taper angle 136 becomes rounded as it transitions to the minimum diameter “M”. Thus, the tubular body 130′ represents a strainer bushing offering a minimum diameter “M” formed by a rounded portion 136′.

It is observed here that the strainer bushing 130′ of FIG. 1D (or, for that matter, the strainer bushing 130 of FIGS. 1B and 1C) may be used with a conventional cage 110. In other words, the improved profile 136, 136′ represents an independent advancement in the art relative to the use of the cone 116.

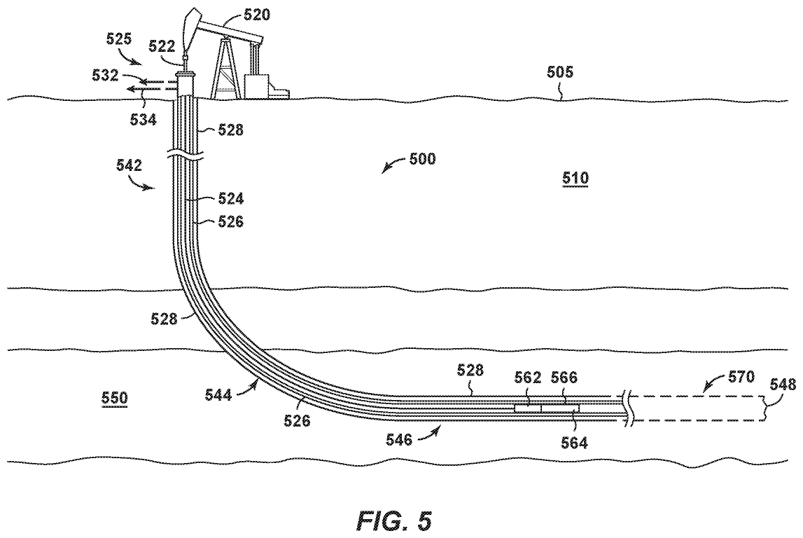

Referring back to FIGS. 1A-1C, the cylindrical body 100 also comprises an upper tubular body 120. As noted above, if the tubular body 120 represents a standing valve (shown at 564 in FIG. 5), then the upper tubular body 120 may be representative of a pump barrel. The outer diameter of the pump barrel will include an upset that is configured to land in a seating nipple (shown at 566 of FIG. 5) along the production tubing 526. If the pump is run as a tubing pump, then the pump barrel may be threadedly connected directly to the production tubing.

On the other hand, if the tubular body 120 represents a travelling valve (seen at 562 in FIG. 5), then the upper tubular body 120 is typically a plunger. The plunger provides for mechanical connection to a sucker rod string (shown at 524 of FIG. 5) within the production tubing (shown at 526). It is understood that the traveling valve 562 and the standing valve 564 work together within a wellbore, along with the rod string 524, forming a positive displacement pump.

The upper tubular body 120 includes a lower end 124 forming a male threaded end. The male threaded end 124 is threadedly connected to the upper female threaded end 112 of the cage 110. The upper tubular body also includes a bore 125 that receives production fluids “F” that flow up through the seat 118. Production fluids will flow around the cone 116 and to the surface through a string of production tubing 526.

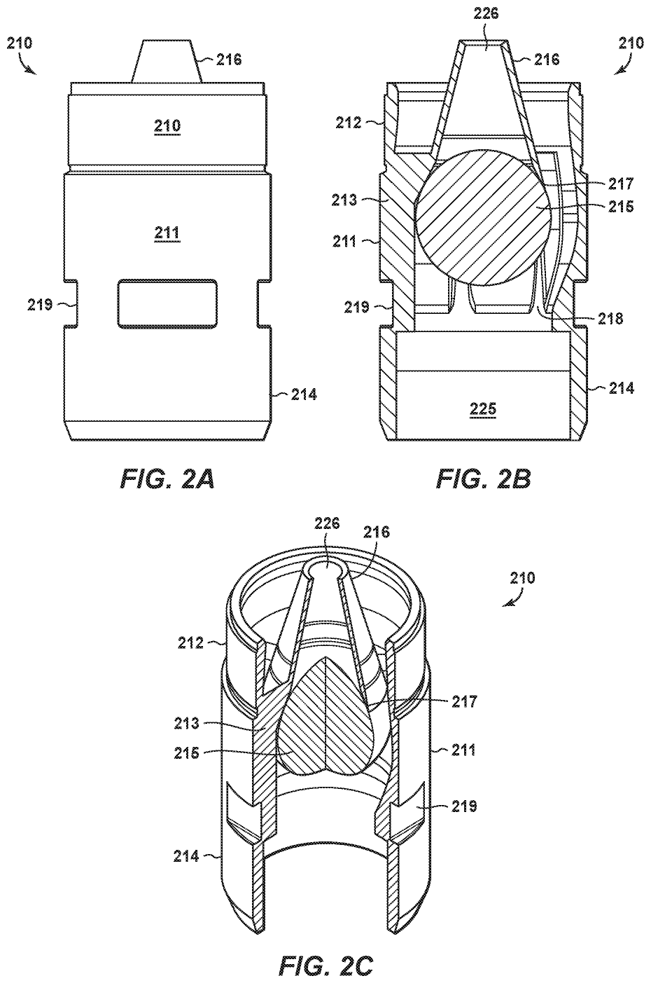

FIG. 2A is a side view of a valve for a positive displacement pump, in an alternate embodiment. In this instance, only the cage 210 for a valve is shown. The cage 210 is an alternate arrangement for the cylindrical body 110 (or cage) of FIGS. 1A-1C.

FIG. 2B is a cross-sectional view of the cage 210 of FIG. 2A. FIG. 2C is a cut-away view of the cage 210 of FIG. 2A. The cage 210 of FIGS. 2A-2C will be discussed together.

The cage 210 defines a tubular body 211. The tubular body 211 forms an axial bore 225 through which production fluids are pumped. The tubular body 211 includes an upper end 212 and a lower end 214. In the arrangement as best seen in FIG. 2B, the upper end 212 is a male threaded end while the lower end 214 is a female threaded end. Thus, the tubular body 311 may be referred to as a “pin-by-box” body. This is the most common arrangement for a downhole valve.

It can be seen that the cage 210 again includes a cone 216. The cone 216 defines a generally frusto-conical body having an open bottom and a ported top 226. The ported top 226 allows production fluids to escape from the cage 216 as the ball 215 travels upward within the valve 210. At the same time, the elongated frusto-conical wall profile helps to streamline the flow of production fluids through the top of the cone 216.

During production, as the ball 215 floats up in the cage 210, the ball 215 will land against a ball stop. Preferably, the ball stop is the cone 216 itself. In one aspect, the ball 215 hits a bottom end of the cone 216, while in another aspect the ball 215 has a slightly smaller diameter than a bottom of the cone 216, and the ball 215 stops against the inner diameter of the cone 216. This point of contact with the cone 216 provides a radial ball stop 217. As noted above, it is also within the scope of the present disclosure to provide a separate ball stop below a lower end of the cone 216. In any instance, the ball stop 217 prevents the ball 215 from floating to the top of the cage 210 or the top of the cone 216.

Two or more ball guides 213 reside below the cone 216. Preferably, three to five ball guides 213 are formed, with the ball guides 213 being equi-radially spaced about the cage 210. It can be seen in FIG. 2B that the tubular wall 211 includes areas of increased thickness. In this embodiment, the increased areas of thickness define the ball guides 213, with fluid flow passages 218 residing between the ball guides 213. Preferably, the upper ends of the ball guides 213 have sharp profiles to minimize turbulence.

It is also noted that the body 211 of the cylindrical body forming the cage 210 comprises a plurality of flat surfaces 219. The flat surfaces 219 may be referred to as “wrench flats.” The flat surfaces 219 are provided to allow the operator to thread the cylindrical body 210 with other tubular components, such as the upper tubular body 120 shown in FIG. 1B.

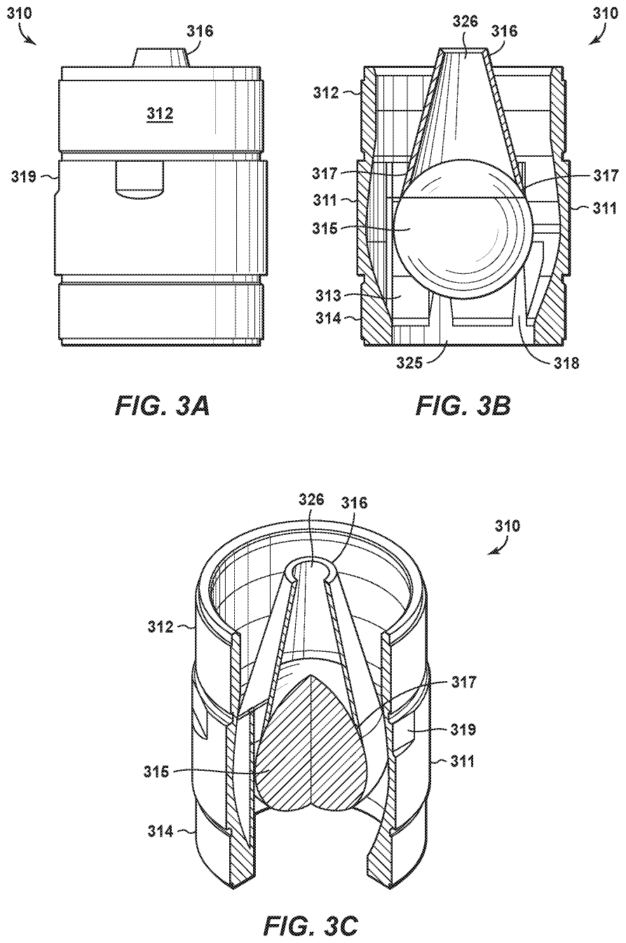

FIG. 3A is a side view of a valve for a positive displacement pump, in yet another alternate embodiment. As with the embodiment of FIG. 2A, only an intermediate tubular body, or cage, 310 for a valve is shown. The cage 310 is an alternate arrangement for the cylindrical body 110 (or cage) of FIGS. 1A-1C.

FIG. 3B is a cross-sectional view of the cage 310 of FIG. 3A. FIG. 3C is a cut-away view of the cage 310 of FIG. 3A. The cage 310 of FIGS. 3A-3C will be discussed together.

The cage 310 defines a tubular body 311. The tubular body 311 forms an axial bore 325 through which production fluids are pumped. The tubular body 311 includes an upper end 312 and a lower end 314. In the arrangement as best seen in FIG. 3B, the upper end 312 is a male threaded end while the lower end 314 is also a male threaded end. Thus, the tubular body 311 may be referred to as a “pin-by-pin” body.

It can be seen that the valve 310 again includes a cone 316. The cone 316 defines a generally frusto-conical body having an open bottom and a ported top 326. A ball stop 317 is formed along the frusto-conical body 316. The ball stop 317 serves an upper limit for the ball 315 as it floats off the seat (such as seat 118 of FIG. 1B) and into its open position. Ball guides 313 again reside below the cone and form a part of the cage 310.

In one arrangement, such as that shown in FIG. 1B, the ball guides 313 may be separate from the wall 311 of the cage 316. In another, such as that shown in FIG. 2B, the ball guides 313 may be manufactured as part of the wall 311. Space 318 reside between the equi-radially disposed ball guides 313 to accommodate the upward flow of fluid (shown at “F” in FIG. 1B).

In the arrangement of FIG. 3B, the cone 316 and the ball guides 313 are integral and are is inserted into the tubular wall 311. The cone 316 may be press-fit or fixed by other means such as adhesive, welding or brazing. In another aspect, the cone 316 and the ball guides 313 are manufactured in a two-piece cage configuration, where the cone 316 and the ball guides 313 are threaded into the base of the tubular wall 311.

It is again noted that the body 311 of the cage 310 comprises a plurality of flat surfaces 319. The flat surfaces 319 are provided to allow the operator to thread the intermediate tubular body of the cage 310 with other tubular components, such as upper tubular body 120 shown in FIG. 3B. The flat surfaces 319 may be referred to as “wrench flats.”

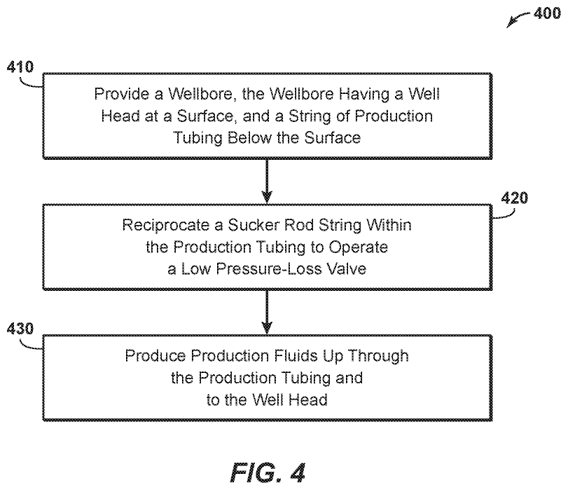

Based on the valves demonstrated in FIGS. 1A-1C, 2A-2C and 3A-3C, a method of pumping fluids from a wellbore is provided herein. FIG. 4 is a flow chart showing steps for a method 400 of pumping fluids from a wellbore, in one embodiment.

The method 400 first comprises providing a wellbore. This is shown in Box 410. The wellbore has a well head at the surface. The wellbore also includes a string of production tubing that extends down from the surface and into a subsurface.

The method 400 also includes reciprocating a sucker rod string within the wellbore. This is seen at Box 420. The sucker rod string is suspended from a pumping unit residing at the surface. The pumping unit, in turn, resides over the well head. The sucker rod string extends down into and reciprocates within the production tubing.

Reciprocation of the sucker rod string serves to operate a downhole positive displacement pump. The positive displacement pump includes a traveling valve at a lower end of the sucker rod string. The pump further includes a standing valve seated along the production tubing a designated location below the traveling valve. The distance between the downstroke of the traveling valve and the seating of the standing valve is preferably minimized to provide a high compression ratio in order to minimize gas interference issues.

The traveling valve, the standing valve, or both are designed in accordance with the valves described above, in any of their embodiments. In this respect, the valve will comprise: a cylindrical body forming a cage, with the cage having an upper end, a lower end and a tubular side wall forming an axial bore; a ball residing within the cylindrical body; two (and preferably three) ball guides configured to keep the ball generally along a centerline of the cage; a cone concentrically residing within the cage, with the cone preferably defining a ported, frusto-conical profile, wherein as the wall converges towards an upper end of the frusto-conical profile, the wall forms a ball-stop that limits upward travel of the ball within the cage, but wherein the cone comprises an open bottom; and a seat residing below the cage, wherein the seat sealingly receives the ball when the ball falls out of the open bottom of the cone, but permits fluids to flow through the seat and around the ball when the ball floats off of the seat and into its open position.

A portion of the cylindrical body below the seat tapers inwardly, providing a minimum inner diameter that is less than a diameter of the seat itself. This would ideally be along the upper end of the strainer bushing.

The valve is designed to decrease pressure loss during pumping, thereby increasing volumetric efficiency, that is, increasing the percentage of the pump stroke barrel that is filled on the downstroke and then lifted on the upstroke. If the pump barrel chamber is not filled, there is lost efficiency.

In designing the valve, the length of the frusto-conical body of the cone may be tuned. Preferably, the valve has a shorter frusto-conical body, such as between 2 inches and 6 inches. This maximizes the compression ratio for the valve while allowing for reduced turbulence above the ball. Where the valve is a traveling valve, then the cone may have a longer frusto-conical body. This reduces turbulent flow above the ball as fluids are pushed into the production tubing.

Preferably, the cage and cone are fabricated from steel. Stainless steels or copper alloys may be used to improve wear and corrosion resistance. The ball guides may have, a wear and corrosion resistant material such as Stellite overlaid on them. Also the cage may be coated for wear and corrosion resistance with material such as chrome, nickel or tungsten carbide. The radial ball stop provided by the frusto-conical body can reduce wear in that location by providing a greater contact area with the ball than the contact area conventionally provided by known ball stops.

In one embodiment, the cone is a solid object and has a concave profile at a bottom end. The concave profile has a radius that approximates the curvature of the ball. Thus, when the ball floats up off of the seat, the ball is snugly captured, further streamlining the inflow of production fluids through the valve.

The method also includes producing production fluids up through the production tubing and to the well head. This is indicated at Box 430.

For reference, FIG. 5 is offered which demonstrates a wellbore 500. The wellbore 500 has been formed for the purpose of producing hydrocarbon fluids to a surface 505 in commercially viable quantities. The wellbore 500 is formed through an earth subsurface 510, and down to a formation 550 where hydrocarbon fluids are found. The formation 550 may be referred to as a “pay zone.” Production fluids flow into the wellbore 500 through openings provided along the completion which may be comprised of perforations, or optionally sand screens, ICDs, gravel pack, open hole, or other completion type. In the illustrative arrangement of FIG. 5, the end completion is shown with slotted liner 570.

Fluids are produced to the surface 505 through the use of a pumping unit 520. The pumping unit 520 is disposed over a well head 525 which receives the produced fluids including hydrocarbons at the surface 505. In the example shown in FIG. 5, the pumping unit 520 is a beam pump; however other types of pumping units may also be used, such as linear hydraulic units. The pumping unit 520 moves a polish rod 522 up and down at the surface 510, through the well head 525. The polish rod 522, in turn, is connected to a rod string 524 that extends down through the earth subsurface 510.

The rod string 524 reciprocates within a string of production tubing 526. It is understood that both the rod string 524 and the production tubing 526 reside within a series of casing strings (shown as a single string of pipe at 528). Primarily liquids are pumped through the production tubing 526 and to the surface 505, and released through line 532. Primarily gas 532 is produced up an annulus between the production tubing 526 and the casing 528, and released through line 534.

The illustrative wellbore 500 of FIG. 5 has been completed horizontally. This means the wellbore 500 has a vertical section 542 and a horizontal section 546. A transition section 5, sometimes referred to as a build section, is formed between the vertical 542 and horizontal 546 sections. The horizontal section 546 extends along the pay zone 550, and terminates at a toe 548. Pumps are typically landed in the build section 544, preferably as deep as possible—and close to the horizontal section 546.

At the end of the rod string 524 are two valves. These represent a traveling valve 562 and a standing valve 564. As discussed above, the traveling valve 562 is connected at the end of the rod string 524 and moves with the rod string 524, while the standing valve 564 is connected to the production tubing 526 and operatively engaged with a seating nipple 566. The traveling valve 562, the standing valve 564, or both may be in accordance with the valves 100, 210 or 310 discussed above.

As observed above, the traveling valve 562, the standing valve 564 and the rod string 524 may together be referred to as a pump. The valve portions 526, 564 of the positive displacement pump are shown in FIG. 5 landed horizontally at the bottom of the well 500. It is preferred to land the valves 526, 564 as deep as possible, and within a relatively straight section of the wellbore 500. However, it is also preferred to land the valves 526, 564 at a more vertical angle such that gravity can assist with ball movements to close the valves.

As can be seen, an improved valve for a positive displacement pump is offered, wherein the valve provides for reduced pressure loss and improved volumetric efficiency. Further variations of the valve and the methods of pumping hydrocarbon fluids from a wellbore herein may fall within the spirit of the claims, below. It will be appreciated that the inventions are susceptible to modification, variation and change without departing from the spirit thereof.

### INDUSTRIAL APPLICABILITY

The systems and methods disclosed herein are applicable to the oil and gas industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions, and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements, and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

What is claimed is:

1. A valve for a positive displacement pump, comprising:
a cylindrical body comprising a cage, with the cage having an upper end, a lower end and a tubular side wall forming an axial bore;
a ball residing within the cage;
two or more ball guides configured to keep the ball generally along a centerline of the cage;
a cone concentrically residing within the cage;
a ball stop residing within the cage and preventing the ball from rising to an upper end of the cone when the ball moves to an open position; and
a seat residing below the cage, wherein the seat sealingly receives the ball when the ball falls to the bottom of the cage, but permits fluids to flow through the seat and around the ball when the ball floats off the seat and into its open position.

2. The valve of claim 1, wherein the wall of the cone forms the ball stop.

3. The valve of claim 2, wherein the cone has a frusto-conical profile with lower and upper ends, and wherein the upper and lower ends are each open.

4. The valve of claim 1, wherein the cone is ported between an open bottom and an upper end, with one or more through-openings residing proximate the upper end of the cone.

5. The valve of claim 3, wherein:
the valve is a traveling valve; and
an upper end of the cylindrical body is configured to be operatively connected to a lower end of a sucker rod string.

6. The valve of claim 3, wherein:
the valve is a standing valve; and
an outer diameter of the cylindrical body is configured to be frictionally lodged within a seating nipple along the production tubing.

7. The valve of claim 3, wherein:
a lower end of the cylindrical body comprises a strainer bushing;
the seat resides between the cage and the strainer bushing; and
an inner diameter of the strainer bushing tapers inwardly immediately below the seat, providing a minimum inner diameter of the strainer bushing proximate the seat that is less than a diameter of the seat.

8. The valve of claim 7, wherein the inner diameter of the cylindrical body below the seat tapers inwardly and ends in the minimum inner diameter abutting the seat.

9. The valve of claim 7, wherein the minimum inner diameter below the seat comprises a rounded portion having an inner diameter that is less than a diameter of the seat, but wherein the tubular side wall of the cylindrical body below the seat terminates with an inner diameter that is larger than its own minimum diameter at a location abutting the seat.

10. The valve of claim 1, wherein:
the tubular side wall comprises an upper tubular body serving as the cage, and a lower tubular body serving as the strainer bushing, with the upper tubular body being threadedly connected to the lower tubular body;
an upper end of the lower tubular body comprises the seat; and
a lower end of the upper tubular body increases in thickness to form an inwardly tapered inner diameter above the seat, and wherein the inwardly tapered inner diameter above the seat terminates at the seat with an inner diameter that is equal to or greater than the inner diameter of the seat.

11. The valve of claim 1, wherein:
the cone has a ported, frusto-conical profile with a tapered angle that is between 5° and 30°, relative to a longitudinal axis of the valve; and
the two or more ball guides comprise at least three equi-radially spaced ball guides residing between the seat and the cone that centralize the ball within the cage, and provide flow channels between the ball guides that permit production fluids to flow up from the seat and around the cone.

12. The valve of claim 11, wherein the ball guides are integral to the tubular side wall.

13. The valve of claim 11, wherein the cone and the ball guides are one integral piece, or cone and the ball guides are two separate pieces connected together within the cage.

14. The valve of claim 11, wherein the cone and the ball guides are one integral piece, and serve as an insert into the tubular side wall.

15. A valve for a positive displacement pump, comprising:
a cylindrical body comprising a cage, with the cage having an upper end, a lower end and a tubular side wall forming an axial bore;
a ball residing within the cage;
two or more ball guides configured to keep the ball generally along a centerline of the cage;
a ball stop residing within the cage and preventing the ball from rising to an upper end of the cage when the ball moves to an open position; and
a seat residing below the cage, wherein the seat sealingly receives the ball when the ball falls to the bottom of the cage, but permits fluids to flow through the seat and around the ball when the ball floats above the seat and into its open position;
and wherein a portion of the cylindrical body below the seat increases in thickness and tapers inwardly, providing an inner diameter proximate the seat that is less than a diameter of the seat.

16. The valve of claim 15, further comprising:
a cone concentrically residing within the cylindrical body above a position where the ball stops in its open position.

17. The valve of claim 15, wherein:
the valve is a traveling valve; and
an upper end of the cylindrical body is configured to be operatively connected to a lower end of a sucker rod string.

18. The valve of claim 15, wherein:
the valve is a standing valve; and
an outer diameter of the cylindrical body is configured to sealingly connected to a seating nipple along the production tubing.

19. The valve of claim 15, wherein:
a lower end of the cylindrical body comprises a strainer bushing; and
the seat resides between the cage and the strainer bushing.

20. The valve of claim 19, wherein the inner diameter of the cylindrical body below the seat tapers inwardly and ends in the minimum inner diameter abutting the seat.

21. The valve of claim 19, wherein the minimum inner diameter below the seat comprises a rounded portion having an inner diameter that is less than a diameter of the seat, but wherein the tubular side wall of the cylindrical body below the seat terminates with an inner diameter that is larger than its own minimum diameter at a location abutting the seat.

22. A method of pumping fluids from a wellbore, comprising:
providing a wellbore having a string of production tubing therein, and a valve for a positive displacement pump along the production tubing, wherein the valve comprises:
a cylindrical body comprising a cage, with the cage having an upper end, a lower end and a tubular side wall forming an axial bore;
a ball residing within the cylindrical body;
two or more ball guides configured to keep the ball generally along a centerline of the cage;
a cone concentrically residing within the cylindrical body above a position where the ball stops in an open position; and
a seat residing below the cage, wherein the seat sealingly receives the ball when the ball falls to the bottom of the cage, but permits fluids to flow through the seat and around the ball when the ball floats off the seat and into its open position;
reciprocating a sucker rod string within the production tubing in order to operate the positive displacement pump; and
producing production fluids up through the production tubing and to a well head at the surface.

23. The method of claim 22, wherein:
the cone has a frusto-conical profile with lower and upper ends;
the upper end of the cone is ported; and
the lower end of the cone is open.

24. The method of claim 22, wherein:
a lower end of the cylindrical body comprises a strainer bushing;
the seat resides between the cage and the strainer bushing; and
the tubular side wall of the strainer bushing tapers inwardly immediately below the seat, providing a minimum inner diameter proximate the seat that is less than a diameter of the seat.

25. The method of claim 24, wherein the minimum inner diameter below the seat comprises a rounded portion having an inner diameter that is less than a diameter of the seat, but wherein the tubular side wall of the cylindrical body below the seat terminates with an inner diameter that is larger than its own minimum diameter at a location abutting the seat.

26. The method of claim 24, wherein:
the valve is a traveling valve that is part of the positive displacement pump; and
an upper end of the cylindrical body is operatively connected to a lower end of the sucker rod string.

27. The method of claim 24, wherein:
the valve is a standing valve that is part of the positive displacement pump; and
an outer diameter of the cylindrical body is lodged within a seating nipple along the production tubing.

28. The method of claim 24, wherein:
the tubular side wall comprises an upper tubular body serving as the cage, and a lower tubular body serving as the strainer bushing, with the upper tubular body being threadedly connected to the lower tubular body;
the seat resides at an upper end of the lower tubular body; and
a lower end of the upper tubular body increases in thickness to form an inwardly tapered inner diameter above the seat, and wherein the inwardly tapered inner diameter above the seat terminates at the seat with an inner diameter that is equal to or greater than the inner diameter of the seat.
